(19) United States
(12) Patent Application Publication
(10) Pub. No.: US 2025/0265419 A1
(43) Pub. Date: Aug. 21, 2025

(54) SEMANTIC SEARCH METHOD USING EXAMPLE SENTENCES AND REARRANGEMENTS AND APPARATUS THEREOF

(71) Applicant: COXWAVE, Seoul (KR)

(72) Inventors: Sang yeop KIM, Seoul (KR); Young hoon AHN, Incheon (KR); Joo won KIM, Incheon (KR)

(73) Assignee: COXWAVE, Seoul (KR)

(21) Appl. No.: 18/947,913

(22) Filed: Nov. 14, 2024

(30) Foreign Application Priority Data
Feb. 20, 2024 (KR) 10-2024-0024270

(51) Int. Cl. G06F 40/30; G06F 16/33

(52) U.S. Cl. CPC G06F 40/30; G06F 16/3347

(57) ABSTRACT

The present disclosure relates to a semantic search method. The method includes at least: acquiring the question from the user, generating answers to the question, defining the answers as example sentences for the question, obtaining a similarity by embedding vectors between the example sentences and stored data, deriving similar data by searching the stored data for each example sentence based on the similarity, assigning a rank to the similar data for each example sentence based on the similarity, arranging the similar data for each example sentence according to the rank, determining a final rank of the similar data for all of the example sentences according to a rearrangement criterion, rearranging the similar data according to the final rank, determining the result data from the rearranged similar data, and outputting the result data to the user.

### CROSS-REFERENCE TO RELATED PATENT APPLICATION

The present application claims priority under 35 U.S.C. § 119 (a) to Korean patent application number 10-2024-0024270 filed on Feb. 20, 2024, in the Korean Intellectual Property Office, the entire invention of which is incorporated by reference herein.

### BACKGROUND OF THE INVENTION

### 1. Field

Embodiments of the present disclosure relate to a semantic search technology.

### 2. Description of the Related Art

Semantic search is one of methods of information search, where a search engine provides search results by understanding the context and meaning beyond simple keyword matching. In other words, semantic search is a technology in which the search engine understands the context and meaning, and analyzes the meaning of search terms in order to find the correct answer to a user's search question, enabling more effective searching and filtering of documents related to the search query, unlike keyword search methods that only look for keyword matches.

Semantic search has developed to allow users to input search queries naturally and provide semantically related results. Previous search engines primarily provided search results based on keyword matching, but this made it difficult to accurately understand user intent and had limitations due to not taking the context of information into account. Specifically, for a user searching for “car,” documents including similar terms or synonyms such as “vehicle” or “automobile” may also be important. However, keyword-based search makes it difficult to handle such synonyms or similar terms. In addition, when the user asks a specific question or needs to consider multiple factors, it is difficult to accurately understand the user's intent and provide an answer using only keywords. For example, to understand a complex search intent such as “high-end restaurant for people who like meat,” semantic information is required.

Recently, with the advancement of Natural Language Processing (NLP) technology, computers have become able to understand the meaning and context of the user's input search terms and generate more accurate search results based on this. Additionally, search engine users want to search in a more natural way and desire search results that are highly relevant to their intent.

Accordingly, the inventor of the present disclosure, after extensive research, has completed the present disclosure to improve the accuracy, efficiency, and user convenience of semantic search, which replaces conventional keyword search.

### SUMMARY OF THE INVENTION

In this background, an object of embodiments of the present disclosure is to provide a semantic search technology using example sentences and rearrangements, which generates a plurality of answers to a question as a plurality of example sentences through a generative AI model, obtains the similarity between the plurality of example sentences and stored data in the domain area, derives similar data based on the similarity, arranges and rearranges the similar data to determine the final rank, and outputs the result data corresponding to the question according to the final rank.

Another object of embodiments of the present disclosure is to provide a semantic search technology using example sentences and rearrangements, which sets and applies a rearrangement criterion a plurality of times to determine the order between similar data and outputs the result data corresponding to the question.

In addition, another unspecified objects of the present disclosure will be additionally considered within the scope that may be easily inferred from the following detailed description and its effects.

In order to achieve the aforementioned objects, one embodiment provides a semantic search method using example sentences and rearrangements which receives a question from a user and outputs result data corresponding to the question, the method including: acquiring the question from the user; generating a plurality of answers to the question; defining the plurality of answers as a plurality of example sentences for the question; obtaining a similarity by embedding vectors between the plurality of example sentences and a plurality of stored data; deriving similar data by searching the plurality of stored data for each example sentence based on the similarity; assigning a rank to the similar data for each example sentence based on the similarity; arranging the similar data for each example sentence according to the rank; determining a final rank of the similar data for all of the plurality of example sentences according to a rearrangement criterion; rearranging the similar data according to the final rank; determining the result data from the rearranged similar data; and outputting the result data to the user.

In the method, the rearrangement criterion may include an intersection variable representing the number of times the similar data is commonly derived for the plurality of example sentences, and a rank variable determining the final rank which represents superiority or inferiority among the similar data for all of the plurality of example sentences based on the rank of the similar data for each example sentence, and the determining of the final rank of the similar data may include deriving two or more ranks for the similar data for two or more example sentences for which the similar data is commonly derived through the intersection variable, and determining the final rank through the rank variable.

In the method, the determining of the final rank of the similar data may include, when the ranks of the similar data are the same, applying a plurality of different rearrangement criteria to determine the order of the similar data.

In the method, the deriving of the similar data may include deriving the similar data according to a range variable which determines the number of similar data to be derived.

In the method, the generating of the answers may include generating the answers according to an example sentence variable which represents the number of the plurality of answers to be defined as the plurality of example sentences.

In the method, the answers may be generated to include keywords corresponding to the question, and the generating of the answers may include generating the plurality of answers to correspond to the question while including different keywords.

Another embodiment provides a semantic search apparatus using example sentences and rearrangements which receives a question from a user and outputs result data corresponding to the question, the apparatus including: an inputter configured to acquire the question from the user; a generative AI model configured to generate a plurality of answers to the question and define the plurality of answers as a plurality of example sentences for the question; an example-based searcher configured to obtain a similarity by embedding vectors between the plurality of example sentences and a plurality of stored data, derive similar data by searching for the plurality of stored data for each example sentence based on the similarity, assign a rank to the similar data for each example sentence based on the similarity, and arrange the similar data for each example sentence according to the rank; a rearranger configured to determine a final rank of the similar data for all of the plurality of example sentences according to a rearrangement criterion, rearrange the similar data according to the final rank, and determine the result data from the rearranged similar data; and an outputter configured to output the result data to the user.

As described above, according to embodiments of the present disclosure, by generating answers, in other words, various example sentences, to a question through a generative AI model and determining the rank among similar data, the accuracy and efficiency may be improved compared to direct semantic search results for the question.

Further, according to embodiments of the present disclosure, by providing more accurate and efficient semantic search results to the user, user experience and convenience may be enhanced.

In addition, even if not explicitly mentioned herein, the effects described in the following specification expected by the technical features of the present disclosure and their potential effects are treated as described in the specification of the present disclosure.

### BRIEF DESCRIPTION OF THE DRAWINGS

FIG. 1 is a diagram illustrating an example of semantic search.

FIG. 2 is a block diagram of a semantic search apparatus using example sentences and rearrangements according to an embodiment.

FIG. 3 is a flowchart representing a general sequence of a semantic search method using example sentences and rearrangements according to an embodiment.

FIG. 4 is a diagram illustrating an example of deriving and arranging similar data in a semantic search using example sentences and rearrangements according to an embodiment.

FIG. 5 is a diagram illustrating an example of rearranging similar data to determine result data in a semantic search using example sentences and rearrangements according to an embodiment.

FIG. 6 is a flowchart of a semantic search method using example sentences and rearrangements according to an embodiment.

The accompanying drawings are illustrated for reference to understand the technical idea of the present disclosure, and the scope of the rights of the present disclosure is not limited thereby.

### DETAILED DESCRIPTION

Hereinafter, some embodiments of the present disclosure will be described in detail with reference to the accompanying drawings. In adding reference numerals to the components of each drawing, it should be noted that the same components are intended to have the same numerals as much as possible, even if they are displayed on different drawings. In addition, in describing the present disclosure, detailed descriptions of related known components or functions will be omitted when it is determined that they may obscure the gist of the present disclosure.

In addition, in describing the components of the present disclosure, terms such as first, second, A, B, (a), (b), etc., may be used. These terms are merely used to distinguish one component from another, and they do not limit the nature, order, or sequence of the corresponding components. When a component is described as being “connected,” “coupled,” or “linked” to another component, it should be understood that the component may be directly connected or linked to the other component, or another component may be “connected,” “coupled,” or “linked” between the components.

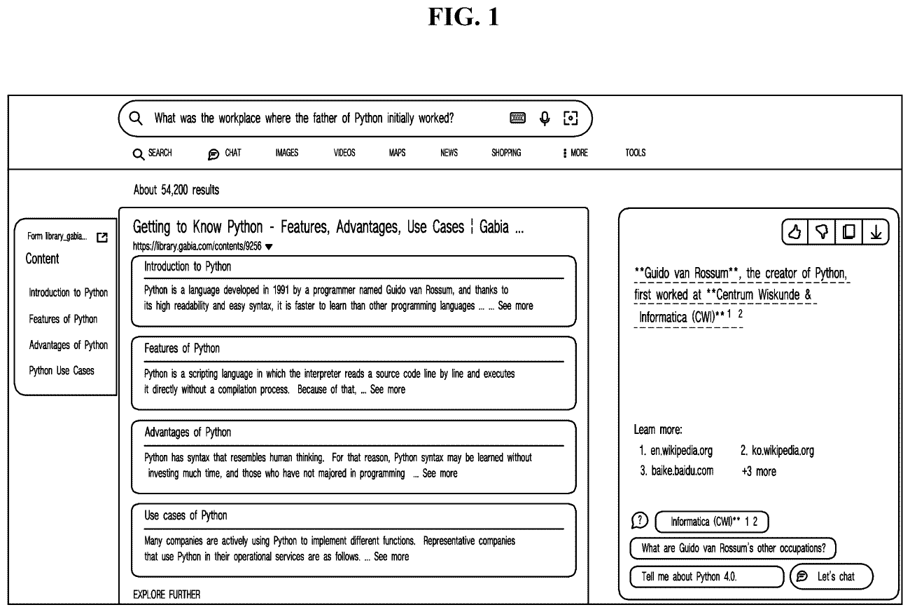

FIG. 1 is a diagram illustrating an example of semantic search.

Referring to FIG. 1, an example of semantic search may be illustrated. Before semantic search, searches were primarily based on keywords, that is, ‘keyword search’ was the mainstream. Keyword search may be the method currently provided by large web portals such as Naver or Google. In a search, a user may input a question. This question is also referred to as a ‘query,’ but in this specification, it will be uniformly referred to as a question instead of a query. When the user inputs a question into the search bar, the portal may identify the keywords of the question and search for data corresponding to the keywords to provide to the user. However, these keyword searches may not provide results that reflect the user's intent and context, as described above. Since this search focuses on keyword matching, it may fail to search the data the user desires if the keyword is not included. Because users must input keywords in the question, it becomes difficult for the users to input a subtle and specific question that reflects their intent.

To make up for the shortcomings of keyword search, semantic search is being utilized. Semantic search may be a method that searches for data corresponding to a question even when the question is input in the form of natural language, rather than keywords, as if asked in daily conversation. Referring to this drawing, as an example of a semantic search, a question about the creator of Python and the results of a semantic search about the creator may be represented. The user wants to know where Python's creator (father) initially worked. In a keyword search, the user may input “Python, Creator, Workplace” or the like. However, it is difficult to convey the meaning or context of ‘initially worked’ with just these keywords. On the other hand, in semantic search, the user may input the question in the form of natural language, such as “What was the workplace where the father of Python initially worked?” This allows interpreting the father of Python as ‘the creator of Python’ and providing data that reflects the intent regarding ‘the workplace where he initially worked’. In this way, in semantic search, when the user directly inputs a question in the form of natural language, data (documents, images, etc.) suitable for that question may be searched and provided. Hereinafter, an improved semantic search will be described to enhance the accuracy of such semantic searches.

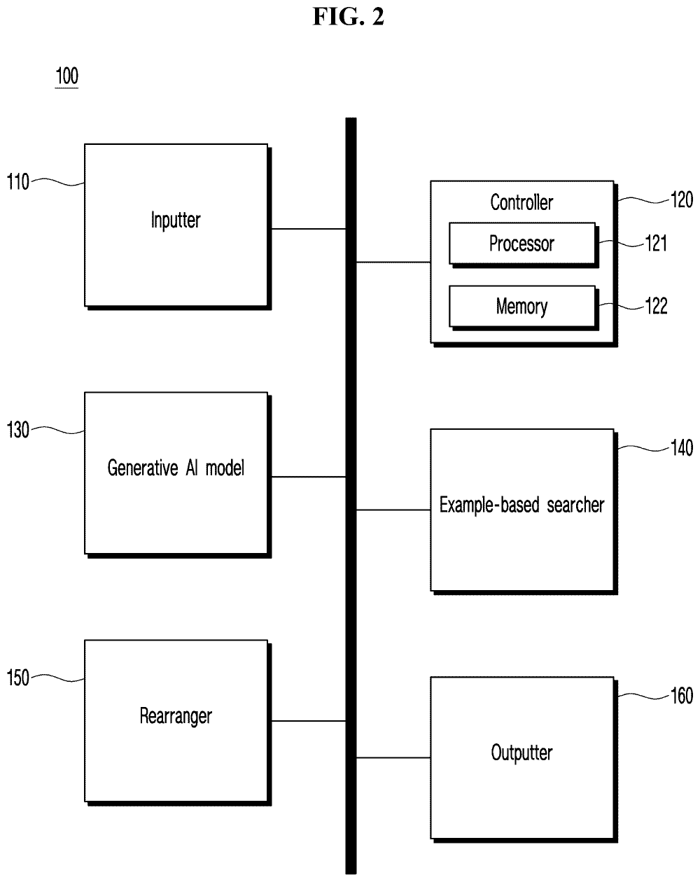

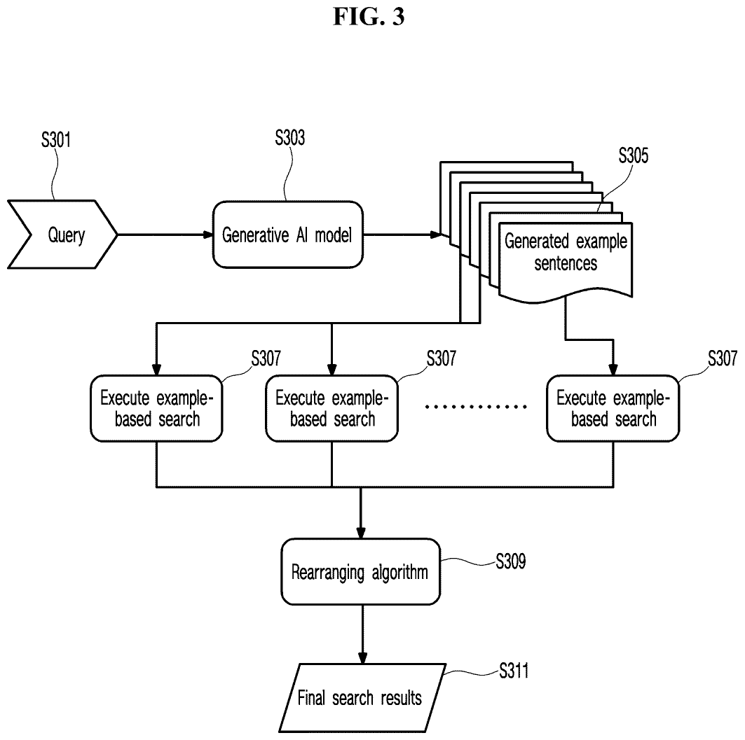

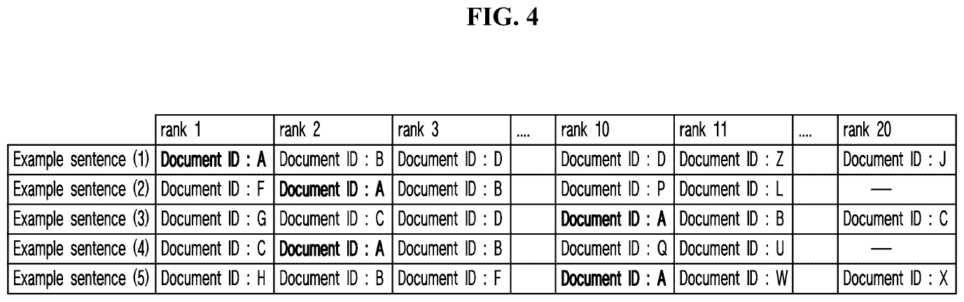

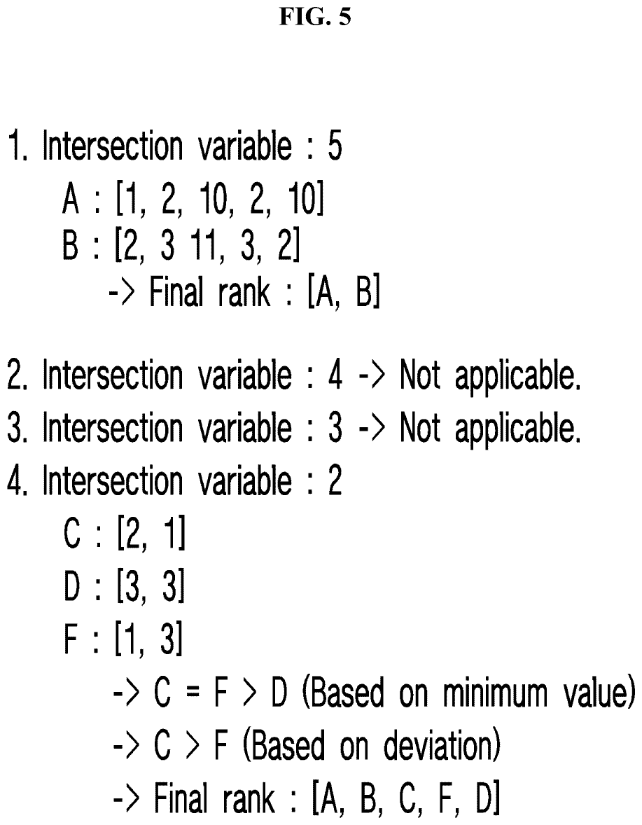

FIG. 2 is a block diagram of a semantic search apparatus using example sentences and rearrangements according to an embodiment, and FIG. 3 is a flowchart representing the general sequence of a semantic search method using example sentences and rearrangements according to an embodiment, and FIG. 4 is a diagram illustrating an example of deriving and arranging similar data in a semantic search using example sentences and rearrangements according to an embodiment, and FIG. 5 is a diagram illustrating an example of rearranging similar data to determine result data in a semantic search using example sentences and rearrangements according to an embodiment.

Referring to FIGS. 2 and 3, a semantic search apparatus using example sentences and rearrangements according to an embodiment (100, hereinafter referred to as an ‘apparatus’) may include an inputter 110, a controller 120, a generative AI model 130, an example-based searcher 140, a rearranger 150, and an outputter 160. The apparatus 100 may be implemented as software modules and hardware modules, and the components described in this specification may be categorized and explained according to their functions, regardless of their form.

A semantic search method performed by the apparatus 100 according to an embodiment may improve the limitations of conventional semantic search. Semantic search has been developed to replace keyword search, but there are limitations to search here. Semantic search may convert the user's natural language question into an embedding vector to search for data based on the similarity between the embedding vector and data accessed in a domain area (e.g., data recorded in a database), and output result data corresponding to the question. This means that if the similarity between the user's question and the embedding vector is recognized, it may be output as result data. This point may still be a limitation of semantic search.

For example, if the user's question is “Who is the father of Python?”, then among ‘Kim Cheol-soo’ and ‘Guido van Rossum’, ‘Guido van Rossum’ may be output as the result data. This is because the latter, ‘Guido van Rossum’ has a higher similarity of embedding vector. On the other hand, between ‘Who is the creator of Python?’ and ‘Guido van Rossum’, ‘Who is the creator of Python?’ may be output as the result data. This is because the former, ‘Who is the creator of Python?’ has a higher similarity of embedding vector. Therefore, semantic search may also derive irrelevant answer. The apparatus 100 according to an embodiment may provide a search method to overcome the limitations of this semantic search.

First, the inputter 110 may receive data from the user to control the apparatus 100. The controller 120 may control the inputter 110 to create and output a user interface for receiving predetermined commands or data from the user. For example, the inputter 110 may include a touchscreen or the like that may receive user input. Specifically, the inputter 110 may receive a question, that is, a query, from the user (step S301). In the case of keyword search, the question takes the form of listing keywords, but in the case of semantic search, it may be a natural language sentence in conversational or written form, as if asked in daily conversation.

The controller 120 may control the overall configuration of the apparatus 100. The controller 120 may set variables to determine the depth or conditions of the search in the semantic search method according to an embodiment. The controller 120 may be programmed to set these variables on its own or obtain variable values from the user through the inputter 110 to set these variables. These variables may include an example sentence variable, an intersection variable, a range variable, and a rank variable. These variables will be explained later.

The controller 120 may include a processor 121 and a memory 122. The memory 122 may store software or programs, and the memory 122 may store a program for performing the semantic search method using example sentences and rearrangements. In addition, the memory 122 may store at least one instruction for operating the apparatus 100 according to the program.

The processor 121 may control the overall operation of the apparatus 100. The processor 121 may include at least one specialized processor corresponding to each function, or may be an integrated form of processor. The processor 121 may execute the program stored in the memory 122, read data or files stored in the memory 122, or store new data or new files in the memory 122. The processor 121 may execute the instructions stored in the memory 122.

The processor 121 may execute a program that performs the semantic search method using example sentences and rearrangements. When the program is executed, the processor 121 may control other components based on the instructions obtained from the program or user input, allowing the operation of the program to be performed. Here, the generative AI model 130, example-based searcher 140, or rearranger 150 may also include their own processor (not shown) and memory (not shown) to perform their assigned operations. Therefore, the processor 121 of the controller 120 may perform other functions except the operations of the generative AI model 130, example-based searcher 140, or rearranger 150. For example, the processor 121 may control each component of the apparatus 100, i.e., the inputter 110, the generative AI model 130, the example-based searcher 140, the rearranger 150, and the outputter 160, or set and adjust the variables in the semantic search method using example sentences and rearrangements.

The generative AI model 130 may obtain a question from the inputter 110 and generate answers to the question (step S303). The generative AI model 130, as a form of artificial intelligence model, may perform machine learning centered around large language models and artificial neural networks, and may generate answers to the user's questions in the form of text (such as dialogue and stories), images (such as photos and videos), or sound (such as music) based on the results of its learning. The algorithms applied to the generative AI model 130 are well-known in various forms in the prior art, so a detailed explanation of this will be omitted.

Here, the user's question may be a natural language question. A natural language question may mean a question in the form of a sentence (either spoken or written) that includes multiple keywords but incorporates the user's intent. The generative AI model 130 may obtain the user's natural language question from the inputter 110 and generate an answer to it. The generative AI model 130 may generate answers multiple times to generate a plurality of answers (step S305). This plurality of answers are predictable answers to the user's question and may be defined as an example sentence. Subsequently, the example-based searcher 140 may receive this plurality of example sentences (plurality of answers) and use each of this plurality of example sentences to search data accessed in the domain area such as data recorded in a database. Hereinafter, the data accessible by the example-based searcher 140 in the domain area, such as data recorded in the database, may be referred to as ‘stored data.’ The example-based searcher 140 may search the stored data based on the similarity with the plurality of example sentences, refer to the derived data as ‘similar data,’ and refer to the final data output to the user after rearrangement of the similar data as ‘result data.’

An example in which the generative AI model 130 generates a plurality of example sentences for the user's question may be as follows. If the user's question is “Find conversation where the users express their joy about the chatbot's performance”, the generative AI model 130 may generate the following four plurality of example sentences. (1) “I'm really impressed with how helpful this chatbot is!”, (2) “Wow, this chatbot is amazing! It solved my issue in no time.”, (3) “I can't believe how smart this chatbot is! It understood exactly what I needed.”, (4) “This chatbot is a lifesaver! It saved me so much time and effort.”, (5) “I'm so happy I found this chatbot. It's made my life so much easier.” Then, the generative AI model 130 may transmit five example sentences to the example-based searcher 140, and the example-based searcher 140 may obtain the similarity by embedding vectors between the five example sentences and the stored data and based on this similarity, derive the result data to be provided to the user.

The generative AI model 130 may generate answers according to an example sentence variable that represents the number of a plurality of answers to be defined as a plurality of example sentences. The example sentence variable may determine how many answers to generate for a single question. The example sentence variable may be transmitted from the controller 120 or obtained from the user through the inputter 110. The generative AI model 130 may generate answers in a number according to this example sentence variable. In the example described above, since the example sentence variable is 5, the generative AI model 130 may generate 5 answers.

By generating a plurality of example sentences and performing semantic search in this way, the probability of searching similar data for each example sentence may increase. If the generative AI model 130 generates a single answer to the question and the example-based searcher 140 searches for data similar to that single answer, only data that is similar to that answer in terms of embedding vectors will be derived. Due to the limitations of embedding vector similarity, data that aligns with the user's intent may not be output to the user. However, if the generative AI model 130 is set to generate a plurality of example sentences and the example-based searcher 140 searches data for each example sentence, the number of possible cases increases, raising the probability of deriving multiple data. The rearranger 150 may determine the most similar data among the multiple data and provide it to the user as the result data. In other words, if similar data increases due to the increase in example sentences, the optimal result data may be derived through an appropriate selection process.

Here, the plurality of example sentences may be generated to include different keywords as much as possible. The generative AI model 130 may be controlled to generate example sentences including different keywords according to a prompt command. These prompt commands may be transmitted from the controller 120 or from the user through the inputter 110. Each example sentence may be used to search the stored data in terms of embedding vector similarity. Because embedding vector similarity has higher responsiveness as keywords match, it may be preferable for each example sentence to include non-overlapping keywords. This is because even if different keywords are included, data matching the user's intent may be searched.

Next, the example-based searcher 140 may search the stored data using the plurality of example sentences to derive similar data that are similar to the plurality of example sentences (step S307). The example-based searcher 140 may receive the plurality of example sentences from the generative AI model 130 and obtain the similarity by embedding vectors between the plurality of example sentences and the stored data. The example-based searcher 140 may obtain the similarity of the embedding vectors for each example sentence and the stored data respectively. In the above example, the example-based searcher 140 may obtain the similarity between each of the five example sentences (1)˜(5) regarding questions about cases where the chatbot performed well and the stored data. Then, stored data similar to each example sentence may be searched and derived as similar data.

The example-based searcher 140 may generate answers according to the range variable that determines the number of data to be derived as similar data. The range variable may determine how many similar data to derive based on the similarity of embedding vectors. Specifically, the range variable may be a first range variable which basically represents the number of data to be derived, such as documents and images, and a second range variable which represents a multiple of the data to be derived. The first range variable may represent the number of data (for example, the number of documents or images) that the example-based searcher 140 is required to derive in a single similar data derivation operation. The second range variable may represent the ratio that determines whether to increase or decrease the number of this data. If a large amount of similar data is derived, the accuracy of the final result data provided increases, while deriving a small amount of similar data has the opposite effect, and the range variable may determine the scope of the similar data to be derived. The range variable may include a value of the product of the first range variable and the second range variable. The example-based searcher 140 may derive similar data in a number corresponding to the value of the product of the first range variable and the second range variable. The range variable may be transmitted from the controller 120 or obtained from the user through the inputter 110. The example-based searcher 140 may derive similar data in a number according to this range variable. In the above example, if the range variable is 2.0 and the intersection variable is 10, the product of the range variable and the intersection variable is 20, so the example-based searcher 140 may derive 20 similar data.

The example-based searcher 140 may assign a rank to the similar data for each example sentence based on similarity when similar data is derived for each example sentence respectively. Even if a plurality of similar data are derived for a given example sentence, the similarity of the similar data will not all be the same. The example-based searcher 140 may assign ranks according to the similarity and arrange the similar data according to those ranks. For instance, in the above example, if 10 similar data are derived for example sentence (1), the 10 similar data may be arranged according to the rank of their similarity. The example-based searcher 140 may perform the same operation for example sentences (2) to (5) as well.

Meanwhile, the rearranger 150 may determine the final rank of the similar data for all of the plurality of example sentences (step S309). If the example-based searcher 140 derives a specific number of similar data for each example sentence and arranges the derived similar data according to the rank of similarity, it then needs to determine which similar data among them should be provided to the user. Only when this is determined may the user be provided with a single answer to the question, that is, the result data. This may be the rearrangement process. Rearrangement may be understood as gathering all similar data for each example sentence and determining their ranks. Although the ranks of similar data for each example sentence are determined according to similarity, in rearrangement, ranks may be assigned for all of the plurality of example sentences. In this process, it will be referred to as “final rank” to differentiate it from the rank.

The rearranger 150 may determine the final rank of the similar data for all of the plurality of example sentences according to a rearrangement criterion. The rearrangement criterion may be the conditions or rules for determining the final rank of the similar data. The rearrangement criterion may include an intersection variable that represents the number of times similar data are commonly derived for the plurality of example sentences, and a rank variable that determines the final rank representing the superiority or inferiority among the similar data for all of the plurality of example sentences, regardless of which example sentence the similar data originated from. The rearranger 150 may apply the intersection variable and the rank variable in turn.

The rearranger 150 may check the similar data commonly derived from at least two or more example sentences according to the value represented by the intersection variable and may derive at least two or more ranks for the similar data. For example, if the intersection variable is 5, it may check the similar data derived from all example sentences (1) to (5) and derive the ranks for example sentences (1) to (5). If the intersection variable is 2, it may check the similar data derived from two or more of the example sentences (1) to (5) and derive the ranks for those two or more example sentences.

And the rearranger 150 may determine the final rank of the similar data among the ranks derived by the intersection variable according to the value or condition represented by the rank variable. The rank variable may be a condition or a value representing that condition. The rank variable may mean deviation, frequency, minimum value, or average, and each condition may be represented as a value (1. 2. 3. 4). If the rank variable is the minimum value, the rearranger 150 may extract the minimum value among the ranks derived by the intersection variable and compare the similar data derived by the intersection variable based on the minimum value to determine one of them. The rearranger 150 may prioritize similar data with a smaller rank over similar data that does not. The rearranger 150 may apply deviation, frequency, and average to the ranks of each similar data, and may determine the final rank of the similar data based on whether the result is smaller. Hereinafter, an example will be described in which the example-based searcher 140 derives similar data and the rearranger 150 rearranges the similar data to determine the result data.

Referring to FIG. 4, an example of deriving and arranging similar data in semantic search using example sentences and rearrangements according to an embodiment is illustrated, and referring to FIG. 5, an example of rearranging similar data to determine result data in semantic search using example sentences and rearrangements according to an embodiment may be illustrated.

The example-based searcher 140 may derive documents as similar data for each example sentence according to the range variable. In the above example, if there are example sentences (1) to (5) and the first range variable is 10 while the second range variable is 2.0, the example-based searcher 140 may derive 20 documents for each example sentence, calculated as 10×2=20. The example-based searcher 140 may assign ranks to the 20 documents for each example sentence. Ranks are assigned in order of the highest similarity of the embedding vectors, but it is not limited to this, as other similarity judgment criteria may be applied. Thus, for example sentence (1), the document IDs A, B, D, . . . , D, Z, . . . , J may be derived as similar data. For example sentence (2), F, A, B, . . . , P, L, . . . may be derived as similar data. Similarly, for example sentences (3) to (5), similar data may also be derived, and ranks from rank1, rank2, . . . rank20 may be assigned. Then, the example-based searcher 140 may arrange the similar data in order of rank.

In this way, when similar data are derived for each example sentence, the rearranger 150 may select similar data as the result data to be provided to the user through the rearrangement process. The rearranger 150 may determine the similar data to be provided as the result data. The rearranger 150 may determine the final rank of similar data encompassing all of the plurality of example sentences according to the rearrangement criterion. The rearranger 150 may extract commonly derived similar data through the intersection variable and determine the superiority or inferiority among that similar data through the rank variable. In the above example, if the intersection variable is 5 and the rank variable is the minimum value, the rearranger 150 may select documents A and B derived from all example sentences (1) to (5). And the rearranger 150 may represent the rank that document A holds in each example sentence and the rank that document B holds in each example sentence, respectively. The rank of document A may be [1, 2, 10, 2, 10], and the rank of document B may be [2, 3, 11, 3, 2]. Next, the rearranger 150 may determine the ranks between document A and document B based on the minimum value of the rank. The minimum value of the rank of document A may be 1, and the minimum value of the rank of document B may be 2. In the present example, since the rank of document A is smaller than that of document B based on the minimum value, the final rank may be document A>document B.

Here, if the rearranger 150 may not determine the final rank of similar data using a single rearrangement criterion, it may utilize a plurality of rearrangement criteria. In the above example, the rearrangement criterion in which the intersection variable is set to 5 may be referred to as a first rearrangement criterion. The rearrangement criteria applied subsequently may be second, third, . . . rearrangement criteria. Since the ranks of other similar data in addition to document A and document B also need to be considered, the rearranger 150 may apply the second to fourth rearrangement criteria. The rearranger 150 may use the second rearrangement criterion with an intersection variable of 4 and the third rearrangement criterion with an intersection variable of 3 to derive the final rank. However, since no common documents are derived, the rearranger 150 may not determine the final rank for documents other than document A and document B.

The rearranger 150 may apply the fourth rearrangement criterion with an intersection variable of 2. The rearranger 150 may extract documents that are commonly derived from two example sentences, and those documents may be C, D, and F. The ranks for each document may be [2, 1], [3, 3], and [1, 3], respectively. Since the rank variable is the minimum value, the rearranger 150 may determine the ranks of documents C, D, and F as 1, 1, and 3, respectively. The final rank will be document C=document F>document D, but the superiority or inferiority between documents C and F is still undetermined. This time, the rearranger 150 may determine the superiority or inferiority of documents C and F based on the deviation instead of the minimum value for the rank variable. Since the deviation is smaller for document C, the rearranger 150 may determine the superiority or inferiority as document C>document F. Finally, the rearranger 150 may determine the final rank among documents A, B, C, D, and F as A>B>C>F>D. Here, if the intersection variable is smaller, it is sufficient for it to be derived in common from at least two or more, so it may be interpreted as a more relaxed criterion. Therefore, A and B may be prioritized over C, D, and F. In addition, if the superiority or inferiority of the similar data is not determined, the rearranger 150 may adjust the range variable or rearrangement criterion (intersection variable, rank variable) and apply them repeatedly.

Returning to FIG. 2, the rearranger 150 may rearrange the similar data according to the final rank. The rearranger 150 may determine the result data to be provided to the user from the rearranged similar data. The outputter 160 may output data to the user and may include a user interface for this purpose (step S311). The outputter 160 may output the result data to the user once it acquires the result data from the rearranger 150. Here, the rearranger 150 may select one or more similar data as the result data according to the final rank. In the above example, the rearranger 150 may provide only document A as the result data or provide both document A and document B. Then the user may receive result data such as document A (or document B) in response to the user's question, “Find conversation where the users express their joy about the chatbot's performance.”

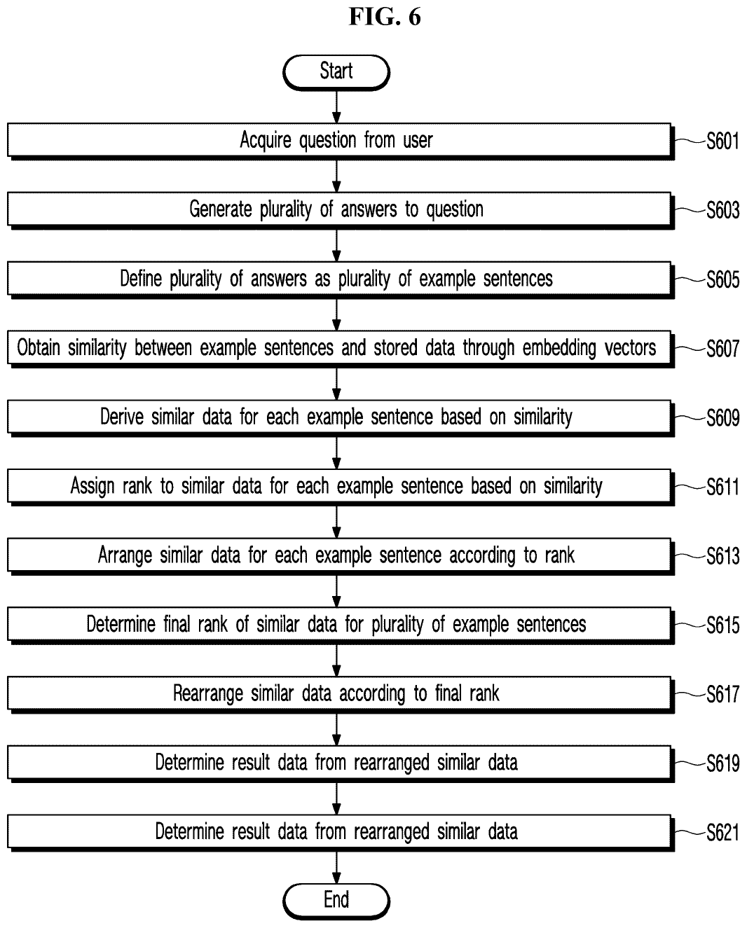

FIG. 6 is a flowchart of a semantic search method using example sentences and rearrangements according to an embodiment.

Referring to FIG. 6, the order of the semantic search method by the semantic search apparatus using example sentences and rearrangement according to an embodiment may be illustrated.

The inputter of the apparatus may acquire a natural language question from the user (step S601). A natural language question may be understood as a colloquial or written sentence that includes keywords but incorporates the user's intent or context.

The generative AI model of the apparatus may generate answers to the user's natural language question (step S603). The generative AI model may generate a plurality of answers corresponding to the question and may generate them to include different keywords due to the characteristics of embedding vector similarity judgment. And the generative AI model may define the plurality of answers as example sentences for the question (step S605).

The example-based searcher of the apparatus may obtain the similarity by embedding vectors between the plurality of example sentences and the stored data (step S607). The example-based searcher may convert the example sentences and the stored data into embedding vectors, respectively, to obtain the similarity in terms of the embedding vectors. If the embedding vectors are similar, the example sentences and the stored data may be considered similar.

The example-based searcher of the apparatus may search the stored data for each example sentence based on the similarity to derive similar data (step S609). The example-based searcher may assign ranks to the similar data for each example sentence based on the similarity (step S611). In addition, the example-based searcher may arrange the similar data (in order of similarity) according to the rank for each example sentence (step S613).

Next, the rearranger of the apparatus may determine the final rank of the similar data for all of the plurality of example sentences according to the rearrangement criterion (step S615). Further, the rearranger may rearrange the similar data according to the final rank (step S617). While the previous arrangement step determines the ranks of similar data for individual example sentences, the rearrangement step may select the similar data that is most similar with the question across all example sentences. The final rank may be reflected here. The similar data rearranged according to the final rank may be considered as several similar data that are most suitable for the question.

Further, the rearranger may determine the similar data to be provided as the result data among the rearranged similar data (step S619). The outputter may receive the result data from the rearranger and may output the result data to the user (step S621).

The terms “include”, “constitute” or “have,” as described above, mean that the respective components may be inherent unless there is a specific contrary statement, so they should be construed as not excluding other components but rather as being able to further include other components. All terms, including technical or scientific terms, have the same meaning as generally understood by a person skilled in the art to which the present disclosure pertains, unless defined otherwise. Generally used terms, such as those defined in a dictionary, should be interpreted to match the meanings in the context of the relevant technology, and unless explicitly defined in the present disclosure, they should not be interpreted in an idealistic or excessively formal manner.

The above explanation is merely an exemplary description of the technical idea of the present disclosure, and a person skilled in the art to which the present disclosure pertains will be able to make various modifications and variations to the extent that it does not deviate from the essential characteristics of the present disclosure. Therefore, the embodiments disclosed in the present disclosure are not intended to limit the technical idea of the present disclosure but to illustrate it, and the scope of the technical idea of the present disclosure is not limited by these embodiments. The scope of protection of the present disclosure should be interpreted by the following claims, and all technical ideas within an equivalent scope should be interpreted as being included in the scope of rights of the present disclosure.

What is claimed is:

1. A semantic search method using example sentences and rearrangements which receives a question from a user and outputs result data corresponding to the question, the method comprising:
acquiring the question from the user;
generating a plurality of answers to the question;
defining the plurality of answers as a plurality of example sentences for the question;
obtaining a similarity by embedding vectors between the plurality of example sentences and a plurality of stored data;
deriving similar data by searching the plurality of stored data for each example sentence based on the similarity;
assigning a rank to the similar data for each example sentence based on the similarity;
arranging the similar data for each example sentence according to the rank;
determining a final rank of the similar data for all of the plurality of example sentences according to a rearrangement criterion;
rearranging the similar data according to the final rank;
determining the result data from the rearranged similar data; and
outputting the result data to the user.

2. The method according to claim 1, wherein the rearrangement criterion comprises an intersection variable representing the number of times the similar data is commonly derived for the plurality of example sentences, and a rank variable determining the final rank which represents superiority or inferiority among the similar data for all of the plurality of example sentences based on the rank of the similar data for each example sentence, and
the determining of the final rank of the similar data comprises deriving two or more ranks for the similar data for two or more example sentences for which the similar data is commonly derived through the intersection variable, and determining the final rank through the rank variable.

3. The method according to claim 2, wherein the determining of the final rank of the similar data comprises, when the ranks of the similar data are the same, applying a plurality of different rearrangement criteria to determine the order of the similar data.

4. The method according to claim 1, wherein the deriving of the similar data comprises deriving the similar data according to a range variable which determines the number of similar data to be derived.

5. The method according to claim 1, wherein the generating of the answers comprises generating the answers according to an example sentence variable which represents the number of the plurality of answers to be defined as the plurality of example sentences.

6. The method according to claim 1, wherein the answers are generated to comprise keywords corresponding to the question, and
the generating of the answers comprises generating the plurality of answers to correspond to the question while comprising different keywords.

7. A semantic search apparatus using example sentences and rearrangements which receives a question from a user and outputs result data corresponding to the question, the apparatus comprising:
an inputter configured to acquire the question from the user;
a generative AI model configured to generate a plurality of answers to the question and define the plurality of answers as a plurality of example sentences for the question;
an example-based searcher configured to obtain a similarity by embedding vectors between the plurality of example sentences and a plurality of stored data, derive similar data by searching for the plurality of stored data for each example sentence based on the similarity, assign a rank to the similar data for each example sentence based on the similarity, and arrange the similar data for each example sentence according to the rank;
a rearranger configured to determine a final rank of the similar data for all of the plurality of example sentences according to a rearrangement criterion, rearrange the similar data according to the final rank, and determine the result data from the rearranged similar data; and
an outputter configured to output the result data to the user.
